(19) United States
(12) Patent Application Publication
(10) Pub. No.: US 2023/0094360 A1
(43) Pub. Date: Mar. 30, 2023

(54) METHOD AND ELECTRONIC VEHICLE SYSTEM FOR PROCESSING V2X MESSAGES

(71) Applicant: Continental Automotive Systems, Inc., Auburn Hills, MI (US)

(72) Inventor: Ulrich Stählin, Nurnberg (DE)

(21) Appl. No.: 17/488,593

(22) Filed: Sep. 29, 2021

(51) Int. Cl. H04L 29/06; H04W 4/40; H04W 4/021

(52) U.S. Cl. CPC H04L 63/123; H04W 4/40; H04W 4/021

(57) ABSTRACT

A method for processing V2X messages by an electronic vehicle system, including receiving a V2X message by a verification device of a V2X communication device, determining whether the V2X message should be verified by the verification device and if no verification of the V2X message is to be carried out: forwarding the unverified V2X message or at least a part of the message content of the unverified V2X message to a processing device, wherein the processing device determines whether an action should be initiated on the basis of the part of the message content; verifying the V2X message if it is determined that an action should be initiated. The disclosure also relates to a corresponding electronic vehicle system and a vehicle, including the vehicle system.

### FIELD OF THE INVENTION

The invention relates to a method and a corresponding electronic vehicle system for processing V2X messages as well as to a vehicle comprising the vehicle system.

### BACKGROUND OF THE INVENTION

Before being sent, vehicle-to-X (V2X) messages are usually cryptographically signed to enable a recipient to verify the integrity of received messages, for example, to ensure that no manipulation of the content has occurred after sending. The terms vehicle-to-X or V2X are used interchangeably within the disclosure.

Essentially, two procedures or test schemes for message verification can be distinguished:
Verification of all received messages (known as Verify all) or
Verification of received messages on demand (known as Verify-on-demand), wherein in particular only those messages that require a warning or action by the recipient are verified.

In particular, the Verify-all approach has a comparatively high demand for computing resources to be provided for realizing the verifications of all incoming messages. Typically, these data processing devices can only handle the required message rates with a given combination of cryptographic curves and key lengths. As the keys become longer or the cryptographic curves become more complex, a sufficient number of messages can no longer be processed. On the other hand, Verify-on-demand is more complex to manage and adds latency after a decision has been made based on the incoming messages.

The US patent 2009/047929 describes an authentication method that can be used by a vehicle equipped with telematics to authenticate an SMS message and provides additional security features that go beyond the SMS protocol. In general, a call center uses a mathematical function to derive a security code, and then sends an SMS message containing information related to the derived security code to a vehicle equipped with telematics. The vehicle equipped with telematics can use the transmitted information to authenticate the sender of the SMS message or its content.

U.S. Pat. No. 6,647,270 B1, incorporated herein by reference, describes a system for providing a communication link between a plurality of mobile units with broadband RF transceivers and antennas. The system describes a plurality of data packets between a plurality of mobile units, with each unit having a unique identifier. The data packets are constructed from a plurality of data fields, including transmitter information and receiver information, the transmitter information having a unique identifier of the transmitter and information derived from a position signal obtained by means of a GPS receiver. The receiver information includes the address of the desired remote unit.

US patent 2011/304425, incorporated herein by reference, discloses a communications system configured to operate in an ad hoc wireless network, which comprises a transmission device configured to send and receive a message, a signature module configured to generate a hierarchical signature using the message, and a validation module that is configured to hierarchically validate a predetermined section of a hierarchically signed message.

A computationally efficient message validation strategy which, in conjunction with a broadcast authentication protocol that uses a combination of a digital signature and a TESLA-MAC to authenticate messages, achieves non-rejection and resilience against computer-assisted denial-of-service attacks is described in US 2011/0238997, incorporated herein by reference. When messages are received by a recipient, the verification strategy separates the messages into messages with the same sender identification. The strategy then determines whether the TESLA-MAC authenticator is valid for each message and discards the messages that do not have a valid TESLA-MAC. The strategy collects the messages with a valid TESLA-MAC for each sender identifier and performs a batch verification process for the message group to determine whether the messages in the group have a valid digital signature. This strategy validates each message in the message group if the batch verification process shows that the message group has a valid digital signature.

US patent 2009/0254754 A1, incorporated herein by reference, provides a system and a method for a vehicle-to-vehicle communication system which provides active security applications that use simple geographic authentication using unique signatures. The system and the method require each vehicle to create a discretized representation of its trajectory, which records its kinematic history with an adjustable degree of accuracy and with an adjustable scope in the past. This trajectory information is then signed with a unique signature. Thus, with each periodic message the sending vehicle sends the standard application payload, a signed version of the trajectory, and the digital signature across all fields.

DE 10 2004 056 724 A1, incorporated herein by reference, describes a method for transmitting data in a communication network with direct vehicle-vehicle communication, wherein a receiving vehicle receives communication signals from a transmitting vehicle. The receiving vehicle determines or updates trust information, the trust information being used to determine whether the data sent by the sending vehicle is trustworthy and/or how trustworthy the data sent by the sending vehicle is. The trust information is obtained by using a user certificate issued by a trusted institution and/or generated by a device in the communications network by using information from a first certificate issued by the trusted institution.

In order to reduce the computational load required for the verification of received vehicle-to-X messages, in KRISHNAN, Hariharan, WEIMERSKIRCH, Andre: “Verify-on-Demand”—A Practical and Scalable Approach for Broadcast Authentication in Vehicle Safety Communication. In: Society of Automotive Engineers (SAE) technical paper series, published Apr. 12, 2011, ISSN 0148-7191, pp. 1-11, incorporated herein by reference, a method for on-demand verification of received vehicle-to-X messages is described, wherein verification is only carried out for messages above a specified security risk threshold.

DE 10 2007 053 255 A1, incorporated herein by reference, discloses a method for processing messages in a message processing device, wherein a metric of a priority for security validation of a received message is determined depending on the message content, and a processing sequence for further message processing for security validation is defined and implemented, taking into account a respective authentication element of each message depending on the values of the priority metric for the security validation of the messages. For example, the priority metric can be determined depending on an impending threat situation identified on the basis of the message content.

US patent 2010/0049976 A1, incorporated herein by reference, provides a system and a method for adaptive verification of data in resource-constrained systems, wherein a suitable validation mode is selected to strike a balance between cost and performance requirements and security requirements. The algorithm uses a trust level for the validity of a received message and assigns the trust level to a scale between a bona fide message at one end of the scale and a malicious message at the opposite end of the scale. Depending on the scale of the trust level and/or the amount of unprocessed data in a cache memory, it is determined which validation mode will be used to authenticate the message.

DE 10 2012 204 880 B4, incorporated herein by reference, relates to a method for selectively testing data security sequences of received vehicle-to-X messages, in which a number of vehicle-to-X messages are received and/or sent in an operating cycle of a vehicle-to-X communication system, wherein a vehicle-to-X message comprises a data security sequence, wherein a reliability assessment of the received vehicle-to-X message is carried out during the operating cycle by checking the data security sequence and wherein an information content of the received vehicle-to-X message is read during the operating cycle without prior checking of the data security sequence, wherein a subset of the number of received vehicle-to-X messages is selected in the operating cycle on the basis of the information contents and only the data security sequences of selected vehicle-to-X messages are checked, and the selection is made on the basis of the information contents by taking into account a comparison of the information contents with information contents of information collected by means of at least one environmental sensor, wherein the vehicle-to-X messages, the information contents of which match the information contents of the information collected by means of the at least one environmental sensor, are not selected.

WO 2020 064 066 A1, incorporated herein by reference, relates to a method for filtering vehicle-to-X messages, wherein a number of vehicle-to-X messages is received and a filter parameter for filtering the received vehicle-to-X messages is adjusted in such a way that a number of vehicle-to-X messages to be discarded leaves a remaining number of vehicle-to-X messages to be processed from the number of vehicle-to-X messages received. The adjustment is made as a function of a correction value for describing a deviation in the number of vehicle-to-X messages to be processed within a specified time period from a number of vehicle-to-X messages intended for processing within the specified time period. This ensures a continuous dynamic adaptation of the filter parameter in such a way that the number of vehicle-to-X messages to be processed enables the optimal resource utilization.

### SUMMARY OF THE INVENTION

An aspect of the invention can be considered to be to provide a means which allows a resource-saving verification of received vehicle-to-X messages to be achieved.

This is achieved by means of a method or an electronic control device according to at least one of the described embodiments.

According to a first aspect, the disclosure relates to a method for processing V2X messages by an electronic vehicle system, comprising the steps:
receiving a V2X message by a verification device, in particular for checking the integrity of a data content of the V2X message of a V2X communication device;
determining whether the V2X message should be verified by the verification device and if no verification of the V2X message is to be carried out:
   forwarding the unverified V2X message or at least part of the message content of the unverified V2X message to a processing device, wherein the processing device determines whether an action should be initiated on the basis of the part of the message content;
   verifying the V2X message if it is determined that an action should be initiated.

The underlying idea is to provide an improved approach to the verification of received vehicle-to-X messages, in particular by an optimized combination of the verify-all and verify-on-demand procedure. With the solution described, a flexible verification can be implemented and a dynamic response to changes in cryptographic algorithms and/or signatures of messages can be performed without the need for updates to the underlying verification approach.

The processing device is an electronic control unit and/or a computing device, for example. According to an extension, the processing device is separate from the verification device or the vehicle-to-X communication device. For example, the processing device forms an electronic control unit of a driving assistance system and/or a (partially) autonomous driving system. In particular, the processing device is designed to process message content or a received message and to initiate actions based on an evaluation of at least a portion of the message content. The assessment of whether an action should be taken need not be based on the whole of the message content, but may also be based on a portion of the received part of the message content.

The processing device determines whether an action should be taken based on the portion of the message content. In accordance with at least one embodiment, it is deemed that an action should be initiated if, in particular by taking into account the part of the message content and/or information obtained from vehicle sensors and/or other sources, it is determined that a safety-critical situation that may cause harm to road users exists or is potentially imminent. A safety-critical situation is, for example, a collision with another road user and/or with another object. An action to be initiated should therefore in particular be understood as an action to be taken to resolve a safety-critical situation in order to avoid an accident. In this sense, the initiation of an action may include the issuing of a signal by the processing device to output a warning signal to a driver of the vehicle and/or other road users. In particular, a warning can be transmitted to other road users via the V2X communication device. Accordingly, the initiation of a measure may also consist of an intervention in the dynamics of the vehicle by brake engagement, for which the processing device may be designed, for example, to output a signal for changing the dynamic response to an electronic control device for brake activation.

In the step of determining whether a verification of the V2X message should be carried out, a distinction is made between verify-all and verify-on-demand, wherein in particular at least one decision criterion is invoked for the determination. For example, if sufficient resources can be provided by the verification device that is verifying the received messages, the verify-all approach is the simplest and most direct way of verifying incoming messages. At least one alternative or supplementary criterion for determining whether a received V2X message should be verified by the verification device can also be invoked, according to at least one embodiment. In this sense, verify-all forms only a special case of verify-on-demand, all incoming messages are verified before the messages are forwarded and the message content contained by the messages is at least partially used by processing devices to determine any actions to be taken based on the message content. Message content should be understood in particular to mean the payload of the received message, or the information contained in the message.

When verify-on-demand is performed, if the verification device determines that no verification of the V2X message will be carried out, the message, or at least part of the message content, is nevertheless forwarded to the processing device and the latter determines, based on the message content of the received V2X message, whether an action should be initiated and then the V2X message is verified if an action should be initiated. In particular, it can be ensured that even when performing verify-on-demand, messages that require the initiation of an action are evaluated and verified and the measures are initiated, which as a result can avoid any safety-critical situations in traffic.

In accordance with at least one embodiment, if it is determined that an action should be initiated, the verification of the V2X message by the processing device is triggered by issuing an instruction signal to the verification device and/or the processing device performs the verification itself. Messages or message contents can in principle be stored by the processing device and/or the verification device.

According to at least one embodiment, the determination of whether the V2X message should be verified depends on a value describing the computational load of the verification device, wherein the received V2X message is verified by the verification device if a value describing the computational load of the verification device is below a first threshold value and at least one further criterion is used for determining whether the V2X message should be verified, if the value describing the calculation load of the verification device is above a second threshold value. A difference between the first and second threshold value creates a hysteresis, which enables a more consistent behavior with fewer switching operations.

In accordance with at least one embodiment, a switchover from verify-on-demand to verify-all takes place if a value describing the computational load of the verification device falls below a first threshold value. The value describing the computational load thus forms a criterion used for determining whether a received V2X message should be verified.

According to at least one embodiment, a switch from verify-all to verify-on-demand is performed if a value describing the computational load of the verification device exceeds a second threshold value. The second threshold value can be advantageously designed such that the computing resources of the verification device are prevented from being suddenly overloaded due to an increasing reception rate and the verification of new incoming messages from being greatly delayed or temporarily virtually disabled while verify-all is still enabled, but on the other hand, verify-all can also be left activated for as long as possible.

The value describing the computational load can be represented, for example, by detecting the computational load of the verification device as such and/or by a rate of received messages (reception rate) and/or a temperature of the verification device.

According to at least one embodiment, the rate of received V2X messages is stored in a data memory on a location-specific basis and is retrieved from the data memory depending on a determined location of the control device executing the method. The data memory can be part of a provision device, for example a central server, or by a device that also comprises the control device. The central server can be requested to provide the location-dependent reception rate by means of a wireless data communication interface, with the determined location being transmitted to determine the assigned reception rate. The reception rate can therefore also be implemented as location-dependent meta-information of a map.

According to at least one embodiment a location-dependent determination of the rate of received V2X messages is performed, wherein the rate determined on a location-specific basis is stored in the data memory. These determined location-dependent values can be stored in a map as location-dependent metadata, for example. In particular, the generations of new data as well as additions and/or updates of existing values for describing the location-dependent reception rate occurring are possible.

The map and/or the values used to describe occurring message rates may be stored in a data memory of the underlying device, such as the vehicle, and/or may be provided externally by means of an appropriate data connection from a provision device, such as a server.

According to at least one embodiment, the result of determining whether the V2X message should be verified depends on a cryptographic algorithm used and/or a curve used and/or a key length used for the V2X message. The cryptographic algorithm used and/or the curve used and/or the key length used also represent, in particular, indicators of a value describing the computational load on the verification device when the verification is being performed by the verification device.

The cryptographic algorithm used and/or the curve used and/or the key length used shall mean, in particular, the cryptographic algorithm applied by a sender of the message and/or the curve used and/or the key length used.

According to at least one embodiment, as the result of determining whether the V2X message should be verified, the received V2X message will not be verified if, taking into account the available resources of the verification device, its cryptographic algorithm and/or curve and/or key length does not allow verification of the V2X message by the verification device within a period of time equal to or less than a time threshold. According to at least one embodiment, in the step of determining whether the V2X message should be verified, the verification of the received V2X message to be performed is confirmed if, taking into account the available resources of the verification device, its cryptographic algorithm and/or curve and/or key length allows a verification of the V2X message by the verification device within a period of time below a time threshold. This allows a verification of the largest possible number of received messages, taking into account available computing resources. In particular, received messages are not verified and/or not further processed and/or discarded, if their verification places comparatively high requirements on the computing resources to be provided or if their verification by the verification device is not even feasible, for example due to a cryptographic algorithm that is not supported by the verification device.

Received messages that are not verified can be forwarded to a processing device of the underlying receiving device for verification, according to an extension. An underlying receiving device is, for example, a vehicle that also comprises the verification device.

According to at least one embodiment, the V2X message is assigned to one of at least two classes depending on the cryptographic algorithm and/or curve and/or key length used, wherein in the event of assignment to a first class, the result of determining whether the V2X message should be verified is that no verification will be carried out. A plurality of cryptographic algorithms and/or curves and/or key lengths can be assigned to the first class and/or the at least one additional class. The at least one cryptographic algorithm assigned to the first class and/or the at least one curve assigned to the first class and/or the at least one key length assigned to the first class is advantageously different to the at least one cryptographic algorithm and/or curve and/or key length assigned to the at least one additional class. According to an extension, for V2X messages of a second class, in the step of determining whether a verification of the V2X message should be carried out, it is generally determined that a verification should be carried out, wherein the execution of the verification can additionally depend on some of the other alternative or supplementary criteria described.

According to at least one embodiment, a first received V2X message of a respective sender is always verified without exception. In this way, a basic trust can be established in the sense of the sender being known to the receiver. According to an extension, a received message that was sent by an already known sender is not necessarily verified, but rather is verified or processed according to some of the other conditions described in the present disclosure.

According to at least one embodiment, the verification device issues status information for describing a current verification status of the received message and/or for describing a current verification scheme for reception by the processing device. This allows the processing device to be informed of whether the message has already been verified and/or which verification scheme is currently active. The processing device can also be informed by the verification device in particular as to which verification method is used and what effects this will have. These status information items can either be made generally known in the communication network of the underlying system or via message if mixed approaches are used. For example, if the test scheme used by the verification device is changed, during processing of one or more message contents or V2X messages by the processing device, due to the direct or indirect information about the current verification status of the V2X message that is constantly available to the processing device, an undefined state due to an unknown verification status can be avoided.

The processing device advantageously determines the verification status of the V2X message and outputs the instruction signal for triggering a verification to the verification device if a verification of the message has not yet been performed and the requirement for a verification based on an action to be initiated is met. If the verification status of the V2X message indicates that the V2X message has already been verified, the relevant action can be initiated immediately if necessary.

According to an extension, it may be planned to discard received V2X messages or message contents if no verification is triggered by the processing device. Alternatively, it may also be provided that the message content or a V2X message is further processed, in particular by the processing device, even if no verification is triggered by the processing device, wherein this case could be provided in particular for message contents that cannot pose any security risk whatsoever. It is also possible to issue an instruction signal to the verification device to cease a verification.

According to at least one embodiment, the verification device issues latency information for describing an estimated verification time of the unverified V2X message for receipt by the processing device. For example, by taking the verification time into account, two messages/message contents received by the processing device with an intervening time interval can be assigned to each other even if they were received at different times due to a failed verification of the first message and successful verification of the second message.

According to at least one embodiment, the latency information is used in determining whether an action should be initiated. Since latency can have a significant impact on the choice of actions to be taken as a result of the verification, the consideration of the latency is already safety-critical at the time of determining the measures. If, for example, a possible collision is detected with a given dynamic response based on the message content of an unverified message, emergency braking may prove to be ruled out as a collision avoidance measure, taking into account the latency resulting from the yet to be performed verification. If the message content of multiple messages is or should be used for evaluating whether to derive an action, the latencies of the verifications of these messages are advantageously added, at least if the verifications are not carried out in parallel.

According to a further aspect, the disclosure relates to an electronic vehicle system for processing V2X messages, comprising a verification device for verifying a received V2X message and a processing device for processing the V2X message and/or a message content contained by the received V2X message. The electronic vehicle system is configured to execute at least one embodiment of the described method.

According to a further aspect, the disclosure relates to a vehicle comprising the described electronic vehicle system. The vehicle may be a motor vehicle, in particular a passenger motor vehicle, a heavy goods vehicle, a motorcycle, an electric motor vehicle or a hybrid motor vehicle, a water-borne vehicle or an aircraft.

In an extension of the specified electronic vehicle system, the system comprises a data memory. In this case, the specified method is stored in the memory in the form of a computer program, and the computing device is provided for executing the method when the computer program is loaded into the computing device from the memory. A computing device can be any device that is designed to process data. In particular, the computing device can be a processor, such as an ASIC, an FPGA, a digital signal processor, a central processing unit (CPU), a multi-purpose processor (MPP), or similar.

According to a further aspect, a computer program comprises program code means in order to perform all the steps of one of the specified methods when the computer program is executed on a computer or one of the specified devices.

According to a further aspect of the invention, a computer program product contains a program code that is stored on a computer-readable data storage medium and that, when executed on a data processing device, performs one of the specified methods.

### BRIEF DESCRIPTION OF THE DRAWINGS

Several embodiments of the invention are specified in the dependent claims. Further possible embodiments also emerge from the following description of exemplary embodiments on the basis of figures.

In the figures:

FIG. 1 shows an exemplary embodiment of the method for processing V2X messages, and

FIG. 2 shows a schematic illustration of an exemplary embodiment of the electronic vehicle system in a vehicle.

### DETAILED DESCRIPTION OF THE PREFERRED EMBODIMENTS

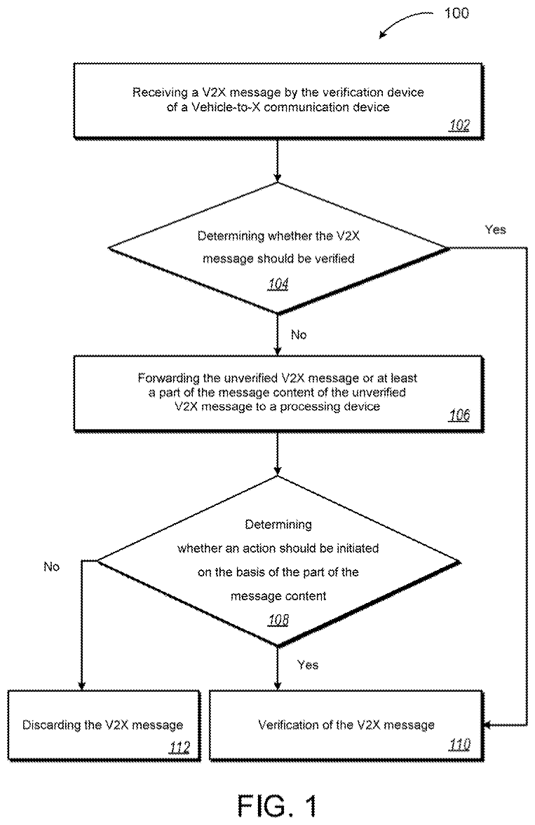

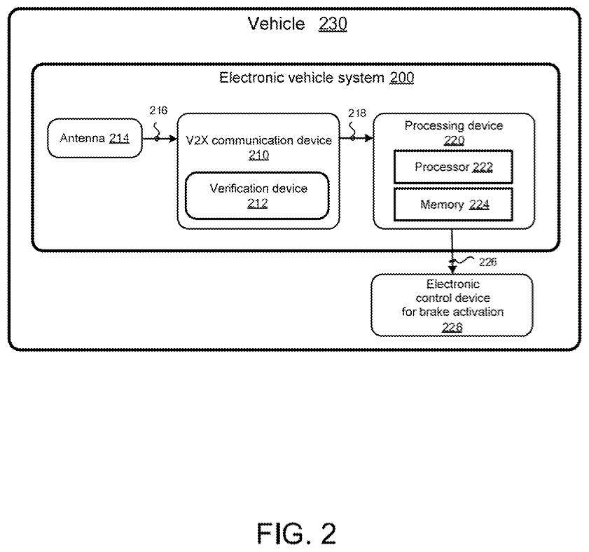

FIG. 1 shows an exemplary embodiment of the method 100 for processing V2X messages by means of an electronic vehicle system 200 according to the embodiment of FIG. 2, wherein in a step 102 a V2X message is received by the verification device of a V2X communication device and determining 104, by means of the verification device, whether the V2X message should be verified by the verification device and if no verification of the V2X message is to be performed, forwarding 106 the unverified V2X message, or at least a portion of the message content of the unverified V2X message, to a processing device. If, for example in step 104, it is determined on the basis of a current verify-all test scheme or at least one other criterion, such as in particular sufficient computing resources, which are checked as part of verify-on-demand, that the verification of the V2X message should be carried out, the verification is carried out in particular by the verification device. The processing device determines in step 108 whether an action should be initiated based on the portion of the message content. If it is determined in step 108 that an action should be initiated, the verification of the V2X message is carried out in step 110. The verification of the V2X message can be carried out by the verification device or by the processing device, wherein the processing device issues an instruction signal for the verification to the verification device if the verification is carried out by the verification device.

On the other hand, if in step 108 it is determined that no action should be initiated, the V2X message is discarded (step 112). Alternatively, it may be planned to use the message content of the unverified V2X message only for non-safety-critical uses.

FIG. 2 shows an exemplary embodiment of the electronic vehicle system 200, comprised by a vehicle 230, for processing V2X messages. The electronic vehicle system 200 comprises a verification device 212 of a V2X communication device 210 for verifying a received V2X message and a processing device for processing the V2X message and/or a message content that the received V2X message comprises. The V2X message 216 can be received by means of antenna 214 and made available to the V2X communication device. The electronic vehicle system 200 is configured to execute an embodiment of the described method. As already described for the exemplary method according to FIG. 1, the V2X communication device is designed to forward the unverified V2X message or at least a part of the message content 218 of the unverified V2X message to the processing device 220 if it has been determined that no verification of the V2X message should be carried out by the verification device 212, at least on the basis of the current test scheme. The processing device 220 is designed to determine whether an action should be initiated on the basis of the part of the message content 216. Furthermore, the processing device is designed to trigger the verification of the V2X message by the verification device 212 or to carry out the verification of the V2X message itself if the processing device 220 determined that an action should be initiated. For the execution of the method, the processing device 220 comprises in particular a computing device, in particular a processor 222, and a memory 224.

The processing device 220 is designed, for example, as an electronic control unit of a driving assistance system and/or a (partially) autonomous driving system. The determination of whether an action should be initiated can therefore result, for example, from requirements to avoid a safety-critical traffic situation, such as a collision with another road user. Accordingly, the initiation of an action may consist of an intervention in the dynamics of the vehicle 230 by engagement of the brakes, for which the processing device 220 can be designed, by way of example, to output a signal 226 for changing the dynamic response to an electronic control device 228 for brake activation.

If it is found in the course of the proceedings that a feature or a group of features is not absolutely necessary, then the applicant aspires right now to a wording of at least one independent claim that no longer has the feature or the group of features. This may be, for example, a subcombination of a claim present on the filing date or a subcombination of a claim present on the filing date that is restricted by further features. Claims or combinations of features of this kind requiring rewording are intended to be understood as also covered by the disclosure of this application.

It should also be pointed out that refinements, features and variants of the invention which are described in the various embodiments or exemplary embodiments and/or shown in the figures can be combined with one another in any desired manner. Single or multiple features are interchangeable with one another in any desired manner. Combinations of features arising therefrom are intended to be understood as also covered by the disclosure of this application.

Back-references in dependent claims are not intended to be understood as a relinquishment of the attainment of independent substantive protection for the features of the back-referenced dependent claims. These features may also be combined with other features in any desired manner.

Features which are only disclosed in the description or features which are only disclosed in the description or in a claim in conjunction with other features may in principle be of independent significance essential to aspects of the invention. They may therefore also be individually included in claims for the purpose of delimitation from the prior art.

In general, it should be pointed out that vehicle-to-X communication is understood to mean in particular a direct communication between vehicles and/or between vehicles and infrastructure devices. For example, it may thus include vehicle-to-vehicle communication or vehicle-to-infrastructure communication. Where this application refers to a communication between vehicles, said communication can fundamentally take place as part of a vehicle-to-vehicle communication, for example, which is typically effected without switching by a mobile radio network or a similar external infrastructure and which must therefore be distinguished from other solutions based on a mobile radio network, for example. For example, a vehicle-to-X communication can be performed using IEEE 802.11p or IEEE 1609.4, SAE 2735, SAE 2945, and ETSI ITS-G5 standards. In addition, new standards are currently being written at 3GPP for C-V2X or LTE-V2X or 5G V2X. A vehicle-to-X communication can also be referred to as C2X communication or V2X communication. The sub-domains can be referred to as C2C (car-to-car), V2V (vehicle-to-vehicle) or C2I (car-to-infrastructure), V2I (vehicle-to-infrastructure). However, an aspect of the invention explicitly does not exclude vehicle-to-X communication with switching via a mobile radio network, for example. In no case is there a restriction to the explicitly mentioned communication technologies.

1. A method for processing V2X messages by an electronic vehicle system, the method comprising:
receiving a V2X message by a verification device of a V2X communication device; and
determining whether the V2X message should be verified by the verification device and if no verification of the V2X message is to be carried out:
forwarding the unverified V2X message or at least a part of the message content of the unverified V2X message to a processing device, wherein the processing device determines whether an action should be initiated on the basis of the part of the message content;
verifying the V2X message if it is determined that an action should be initiated.

2. The method as claimed in claim 1, wherein the verification of the V2X message is carried out by the verification device or by the processing device, wherein the processing device issues an instruction signal for the verification to the verification device if the verification is carried out by the verification device.

3. The method as claimed in claim 1, wherein the determination by the verification device as to whether the V2X message should be verified depends on a value describing the computational load of the verification device, wherein the received V2X message is verified by the verification device if a value describing the computational load of the verification device is below a first threshold value and at least one further criterion is used by the verification device for determining whether the V2X message should be verified, if the value describing the calculation load of the verification device is above a second threshold value.

4. The method as claimed in claim 3, wherein the value describing the computational load is represented by the computational load of the verification device as such and/or by a rate of received V2X messages and/or a temperature of the verification device.

5. The method as claimed in claim 4, wherein the rate of received V2X messages is stored in a data memory on a location-specific basis and is retrieved from the data memory depending on a determined location of the electronic vehicle system executing the method.

6. The method as claimed in claim 5, wherein a location-dependent determination of the rate of received V2X messages is performed, wherein the rate determined on a location-specific basis is stored in the data memory.

7. The method as claimed in claim 1, wherein the result of determining whether the V2X message should be verified depends on a cryptographic algorithm used and/or a curve used and/or a key length used for the V2X message.

8. The method as claimed in claim 7, wherein, as a result of determining whether the V2X message should be verified, the received V2X message will not be verified if, taking into account the available resources of the verification device, its cryptographic algorithm and/or curve and/or key length does not allow verification of the V2X message by the verification device within a period of time equal to or less than a time threshold.

9. The method as claimed in claim 7, wherein the V2X message is assigned to one of at least two classes depending on the cryptographic algorithm and/or curve and/or key length used, wherein in the case of assignment to a first class, the result of determining whether the V2X message should be verified is that no verification will be carried out.

10. The method as claimed in claim 1, wherein a first received V2X message of a respective sender is always verified without exception.

11. The method as claimed in claim 1, wherein the verification device issues status information for describing a current verification status of the received message and/or for describing a current verification scheme for receipt by the processing device.

12. The method as claimed in claim 1, wherein the verification device issues latency information for describing an estimated verification time of the unverified V2X message for receipt by the processing device.

13. The method as claimed in claim 1, wherein the latency information is used in determining whether an action should be initiated.

14. An electronic vehicle system for processing V2X messages, comprising a verification device for verifying a received V2X message and a processing device for processing the V2X message and/or a message content that the received V2X message comprises, wherein the electronic vehicle system is configured to execute a method as claimed in claim 1.

15. A vehicle, comprising an electronic vehicle system as claimed in claim 14.

16. The method as claimed in claim 8, wherein the V2X message is assigned to one of at least two classes depending on the cryptographic algorithm and/or curve and/or key length used, wherein in the case of assignment to a first class, the result of determining whether the V2X message should be verified is that no verification will be carried out. 3.

17. The method as claimed in claim 2, wherein the determination by the verification device as to whether the V2X message should be verified depends on a value describing the computational load of the verification device, wherein the received V2X message is verified by the verification device if a value describing the computational load of the verification device is below a first threshold value and at least one further criterion is used by the verification device for determining whether the V2X message should be verified, if the value describing the calculation load of the verification device is above a second threshold value.
